(19) United States
(12) Patent Application Publication
(10) Pub. No.: US 2019/0368528 A1
(43) Pub. Date: Dec. 5, 2019

(54) BOARD MEMBER FASTENER

(71) Applicant: HANWIT PRECISION INDUSTRIES LTD., New Taipei (TW)

(72) Inventors: Ming-De WU, New Taipei (TW); Chih-Wei CHOU, New Taipei (TW)

(21) Appl. No.: 16/177,932

(22) Filed: Nov. 1, 2018

(30) Foreign Application Priority Data
May 29, 2018 (TW) 107207069

(51) Int. Cl. F16B 19/10; F16B 5/04; B21J 15/04; F16B 5/00

(52) U.S. Cl. CPC F16B 19/10; F16B 5/0096; B21J 15/04; F16B 5/04

(57) ABSTRACT

A board member fastener used to rivet first and second board members including a first board member and a second board member. When the board member faster is punch impacted, it sinks into the interior of the through hole of the first board member to cut the second board member and to deform, and the first board member is forced by the sinking stress of the board member faster and tightly pressed on the second board member upon the punch impact, and thus, the board member faster and the first and second board members are deformed and fitted to each other, achieving a riveting structure that can be applied to different materials and can overcome the deformation caused by heat expansion and contraction.

This application claims the priority benefit of Taiwan patent application number 107207069, filed on May 29, 2018.

### BACKGROUND OF THE INVENTION

### 1. Field of the Invention

The present invention relates to fasteners more particularly, to a board member fastener, which enables a first board member and a second board member to be mutually deformed and fitted, achieving a riveted structure that is applicable to different materials and can overcome the deformation caused by heat expansion and contraction.

### 2. Description of the Related Art

Nowadays, electronic technology is growing at an ever-changing speed, making the development trend of computers move toward the direction of high computing power, fast speed, and small size. Due to that computer performance and quality requirements are getting higher and higher, setting only the basic components in the mainframe will not be enough. It is necessary to continuously expand electronic devices or equipment of enhanced performance, or to connect external computer peripherals so as to meet the needs of users at work or enjoyment.

Furthermore, the server of a general industrial computer usually has arranged therein a plurality of computer components such as motherboard, hard disk, fan module, and power supply. When setting these computer components in a computer mainframe, it is often necessary to join board members in a stack. When two board members are to be fixed together, adhesive bonding, screw joint or fusion is normally employed for non-metal board members. In contrast, metal board members are normally fixed by screwing or riveting, and the reason why metal board members are to be fixed by screwing or riveting is to ensure that the metal board joint structure is not easily separated by external stress. The technique of riveting is to pass a metal pin, which is made with a head at its one end, through holes in two or more board members, and then to hammer the other end of the metal pin into a head after its insertion through the holes in the board members. Riveting is one of the best fixing methods for assembling metal board members without considering the problem of board member disassembly.

The conventional method of riveting two board members is to punch a hole of the same diameter on each of the two board members, then to stack up the two board members, and then to insert a rivet into the holes of the two board members, and then to process the plain end of the rivet into a semispherical head by hot riveting or applying stress so as to hold down the two board members. However, this riveting method has drawbacks. Due to the processing or heat expansion and contraction factors, the deformation of the two board members cannot be eliminated through the simple riveting structure, so that gaps are easily generated between the two board members, resulting in rotation of the two board members about the rivet. This dynamic state does not meet the requirements of riveting. Furthermore, the semispherical head at each of the two opposite ends of the rivet will affect the assembly of adjacent components or cause interference. The aforementioned problems are to be pursued by those skilled in the industry.

### SUMMARY OF THE INVENTION

The present invention has been accomplished under the circumstances in view. It is therefore a main object of the present invention to provide a board member fastener used to rivet at least two board members including a first board member and a second board member. The first and second board members each have drilled therein a different diameter of hole. The first board member provides a first through hole. The second board member provides a second through hole. The top of the first through hole of the first board member is formed with a stop surface that tapers toward the outer diameter so that when the board member faster is punch impacted, the board member faster sinks into the interior of the first through hole to cut the second board member and to deform, and the first board member is forced by the sinking stress of the board member faster and tightly pressed on the second board member upon the punch impact, and thus, the board member faster, the first board member and the second board member are deformed and fitted to each other, achieving a riveting structure that can be applied to different materials and can overcome the deformation caused by heat expansion and contraction.

According to another aspect of the present invention, the first through hole of the first board member has a deep recess so that the board member faster is completely immersed in the first through hole after being punched and impacted. Furthermore, a processing platform is disposed at the bottom side of the second board member so that the bottom portion of the board member faster and the bottom side of the second board member are kept in the same plane, and after the punching riveting process, the two ends of the board member faster are not protruded from the first board member and the second board member, so that the flatness of the two opposite surfaces of the riveted board members can be maintained, having the advantages of good outer appearance and wide application range.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a board member faster in accordance with the present invention.

FIG. 2 is an oblique bottom elevational view of the board member faster in accordance with the present invention.

FIG. 3 is a schematic diagram of a first action of punching and riveting the board member faster and two board members.

FIG. 4 is a schematic diagram of a second action of punching and riveting the board member faster and the two board members.

FIG. 5 is a schematic diagram of a third action of punching and riveting the board member faster and the two board members.

### DETAILED DESCRIPTION OF THE PREFERRED EMBODIMENT

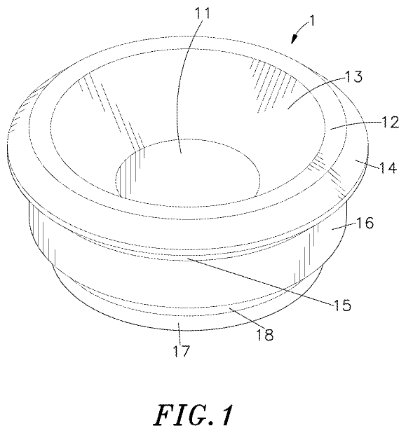

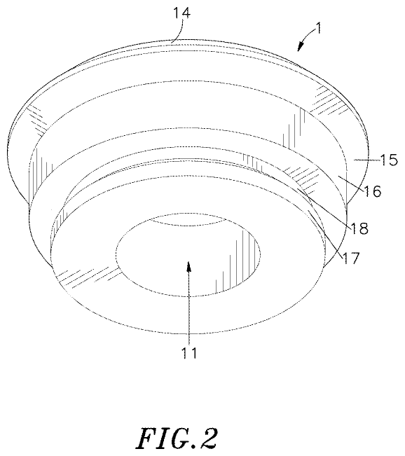

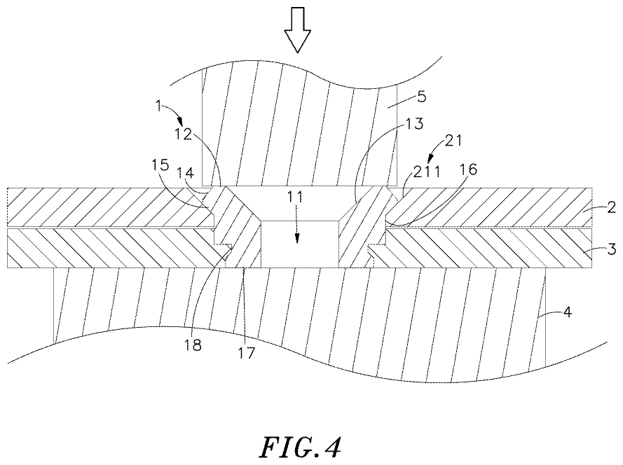

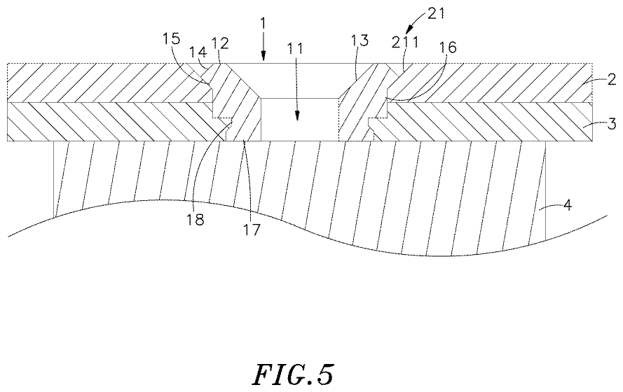

Referring to FIGS. 1-5, an oblique top elevational view of a board member fastener in accordance with the present invention, an oblique bottom elevational view of the board member fastener, a schematic diagram of a first action of punching and riveting the board member fastener and two board members, a schematic diagram of a second action of punching and riveting the board member fastener and the two board members, a schematic diagram of a third action of punching and riveting the board member fastener and the two board members are shown. As illustrated, the board member fastener is used to affix a first board member 2 and a second board member 3. The first board member 2 provides a first through hole 21. The second board member 3 provides a second through hole 31, a board member faster 1 being inserted into the first through hole and the second through hole. By means of punching the board member faster 1, the first board member 2 and the second board member 3 are affixed together, and the gap between the first board member 2 and the second board member 3 is eliminated.

The board member faster 1 comprises:

a hole 11 cut through the center thereof;

a force-bearing portion 12 exhibiting an annular structure and disposed on a top side thereof as a force receiving region of the punching impact;

an inner taper surface 13 exhibiting a funnel-like structure and extending obliquely from an inner side of the force-bearing portion 12 toward the hole 11 and disposed between the hole 11 and the force-bearing portion 12;

an outer taper surface 14 extending obliquely outward from an opposing outer side of the force-bearing portion 12 and disposed outside the force-bearing portion 12;

a beveled surface 15 disposed at an inward turn of the outer taper surface 14, where when the board member faster 1 is punch impacted, the force-bearing portion 12, the inner taper surface 13, the outer taper surface 14 and the beveled surface 15 are deformed and expanded in the first through hole 21 of the first board member 2 and tightly abutted to the first board member 2;

a deformation portion 16 connected to the beveled surface 15 and deformed and pressed in the first through hole 21 and the second through hole 31 when the board member faster 1 is punch impacted;

a bottom portion 17 connected to the deformation portion 16; and

an annular groove 18 disposed between the deformation portion 16 and the bottom portion 17 for the engagement of the second board member 3 when the second board member 3 is deformed upon a punching impact.

The hardness of the board member fastener 1 is greater than that of the second board member 3, and the hardness of the board member fastener 1 is greater than or equal to the first board member 2.

The circular diameter of the first through hole 21 is larger than the circular diameter of the second through hole 31.

The top of the first through hole 21 of the first board member 2 is formed with a stop surface 211 which is gradually enlarged toward the outer diameter for the abutment of the beveled surface 15 of the board member fastener 1.

When the force-bearing portion 12 is punch impacted, the outer taper surface 14 is extended outward to force the beveled surface 15 into abutment against the stop surface 211 of the first board member 2, and the deformation portion 16 is deformed and pressed within the second board member 3 to eliminate the gap between the first board member 2 and the second board member 3.

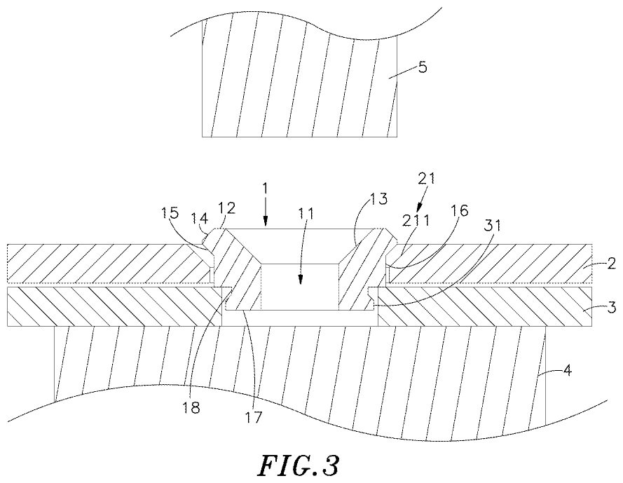

Referring to FIGS. 3-5 again, when the board member fastener 1, the first board member 2 and the second board member 3 are subjected to the punching and impacting process, a processing platform 4 is disposed at the bottom side of the second board member 3, and a punch 5 is disposed above the board member fastener 1, and then the punch 5 is stamped against the force-bearing portion 12 of the board member fastener 1 to complete the punching impact process.

Therefore, the present invention is mainly designed for a board member fastener used to rivet at least two board members 2, 3 (The present invention only cites the riveting structure of two board members but can also be applied to more than two board members, and the riveted structure of more than two board members is still within the protection scope of the present invention). The two board members include the first board member 2 and the second board member 3, each having drilled therein a different diameter of hole. The first board member 2 provides the first through hole 21. The second board member 3 provides the second through hole 31. The top of the first through hole 21 of the first board member 2 is formed with the stop surface 211 that tapers toward the outer diameter (in a funnel-shaped) so that when the board member fastener 1 is punch impacted, the board member fastener 1 sinks into the interior of the first through hole 21, the deformation portion 16 cuts the second board member 3 and deforms, and the stop surface 211 of the first board member 2 is forced by the sinking stress of the board member fastener 1 and tightly pressed on the second board member 3 to eliminate the gap between the first board member 2 and the second board member 3 upon the punch impact, and thus, the board member fastener 1, the first board member 2 and the second board member 3 are deformed and fitted to each other, achieving a riveting structure that can be applied to different materials and can overcome the deformation caused by heat expansion and contraction. Further, the first through hole 21 of the first board member 2 has a deep recess so that the board member fastener 1 is completely immersed in the first through hole 21 after being punched and impacted. Furthermore, the processing platform 4 is disposed at the bottom side of the second board member 3 so that the bottom portion 17 of the board member fastener 1 and the bottom side of the second board member 3 are kept in the same plane, and after the punching riveting process, the two ends of the board member fastener 1 are not protruded from the first board member 2 and the second board member 3, so that the flatness of the two opposite surfaces of the riveted board members can be maintained, having the advantages of good outer appearance and wide application range.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A board member fastener used to affix a first board member and a second board member together, said first board member providing a first through hole, said second board member providing a second through hole, a board member faster being inserted into said first through hole and said second through hole and punch impacted so that said board member faster, said first board member and said second board member are affixed together to eliminate the gap between said first board member and said second board member, said board member faster comprising:
a hole cut through the center thereof;
a force-bearing portion disposed on a top side thereof as a force receiving region of the punching impact;
an inner taper surface extending obliquely from an inner side of said force-bearing portion toward said hole and disposed between said hole and said force-bearing portion;
an outer taper surface extending obliquely outward from an opposing outer side of said force-bearing portion and disposed outside said force-bearing portion;
a beveled surface disposed at an inward turn of said outer taper surface;
a deformation portion connected to said beveled surface and deformed and pressed in said first through hole and said second through hole when said board member faster is punch impacted;
a bottom portion connected to said deformation portion; and
an annular groove disposed between said deformation portion and said bottom portion for the engagement of said second board member when said second board member is deformed upon a punching impact;
wherein when said force-bearing portion is punch impacted, said outer taper surface is extended outward to force said beveled surface into abutment against a stop surface of said first board member, and said deformation portion is deformed and pressed within said second board member to eliminate the gap between said first board member and said second board member.

2. The board member fastener as claimed in claim 1, wherein said force-bearing portion exhibits an annular structure.

3. The board member fastener as claimed in claim 1, wherein said inner taper surface exhibits a funnel-like structure.

4. The board member fastener as claimed in claim 1, wherein said force-bearing portion, said inner taper surface, said outer taper surface and said beveled surface are deformed and expanded in said first through hole of said first board member and tightly abutted to said first board member when said board member faster is punch impacted.

5. The board member fastener as claimed in claim 1, wherein the hardness of said board member faster is greater than that of said second board member.

6. The board member fastener as claimed in claim 1, wherein the hardness of said board member faster is greater than or equal to the hardness of said first board member.

7. The board member fastener as claimed in claim 1, wherein a top of said first through hole of said first board member is formed with said stop surface which is gradually enlarged toward the outer diameter for the abutment of said beveled surface of said board member faster.

8. The board member fastener as claimed in claim 1, wherein the circular diameter of said first through hole is larger than the circular diameter of said second through hole.

9. The board member fastener as claimed in claim 1, wherein when said board member faster, said first board member and said second board member are subjected to the punching and impacting process, a processing platform is disposed at a bottom side of said second board member, and a punch is disposed above said board member faster, and then said punch is stamped against said force-bearing portion of said board member faster to complete the punching impact process.
